(19) United States
(12) Patent Application Publication
(10) Pub. No.: US 2008/0129665 A1
(43) Pub. Date: Jun. 5, 2008

(54) Timing Controller and Liquid Crystal Display Comprising the Timing Controller

(75) Inventors: Teng-Yi Huang, Hsinchu (TW); Yao Jen Hsieh, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 11/745,738

(22) Filed: May 8, 2007

(30) Foreign Application Priority Data
Dec. 1, 2006 (TW) 95144828

(51) Int. Cl. G09G 3/36

(52) U.S. Cl. 345/87

(57) ABSTRACT

A liquid crystal display includes a timing controller, a panel, and a driving chip. The timing controller includes a data pin port, a control pin, and a selector. The data pin port includes a plurality of pins. The control pin receives a control signal. The selector determines a transmission or receiving sequence of signals for the pins of the data pin port according to the control signal. After receiving the signals, the driving chip drives the panel to display according to the signals. Since the sequence of the pins is adaptable, the timing controller may be used in a face up or down configuration depending on the circuitry type of the liquid crystal display.

This application claims the benefit from the priority of Taiwan Patent Application No. 095144828 filed on Dec. 1, 2006, the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention relates to a timing controller; more specifically, the present invention relates to a timing controller adapted for a liquid crystal display.

2. Descriptions of the Related Art

With the rapid development of consumer electronic technology, people are becoming accustomed to using various electronic products, such as electronic multimedia products. One key component of multimedia electronic products is the display. Since a liquid crystal display (LCD) has desirable characteristics such as radiation-free properties, small size, low power consumption, plane square shape, high resolution, and stable display quality, LCDs have started to gradually replace the traditional cathode ray tube displays (CRT displays). Consequently, the LCD is widely used as a display panel of electronic products such as cellular phones, display screens, digital televisions, and notebooks.

Generally, the LCD comprises a panel and a driving circuit. The driving circuit comprises a timing controller, a processor, a plurality of cascaded driving chips, a printed circuit board, and a glass substrate. After the timing controller receives a pixel data signal processed by the processor, it outputs pixel data signals, a control signal, and clock signals according to the timing. The pixel data signals and the clock signals are usually differential signals, and the pixel data signals can be divided into three types: red, green, and blue pixel data signals. The timing controller transmits the pixel data signals to the plurality of driving chips located on the glass substrate through the printed circuit board, and each of the driving chips generates a voltage signal to drive the liquid crystal of the panel according to the pixel data signals.

When designing the driving circuit of the LCD, whether an adopted component of the printed circuit board faces towards a back side (face-up), i.e. the component faces up, or a front side of the LCD panel (face-down), i.e. the component faces down, must be considered first as shown in FIG. 1 and FIG. 2 respectively. Because low voltage differential signals inputted in and reduced swing differential signals outputted from the timing controller chip are in pairs and have reverse polarities with each other, whether or not the pins of the timing controller chip match the input ends of the panel is determined according to the component on the printed circuit board facing towards the front side or the back side of the panel. For example, when the chip is face-up as shown in FIG. 1, the lower leftmost pin of the timing controller 1 is configured to received a LV0− signal, and the following pin is configured for receiving a LV0+ signal. When the chip is face-down as shown in FIG. 2, the lower leftmost pin of the timing controller 1 is configured to receive a LV3+ signal, and the following pin is configured for receiving a LV3− signal. Consequently, the industry often uses two timing controller chips with the same internal control circuits but different sequences of input and output pins to meet actual requirements. These different timing controller chips need to be assembled, transported, and stored separately which increases the overall costs.

Therefore, a timing controller suitable for both face-up and face-down LCD configurations is required by the industry.

### SUMMARY OF THE INVENTION

One objective of the invention is to provide a timing controller comprising a data pin port, a control pin, and a selector. The data pin port comprises a plurality of pins. The control pin is used for receiving a control signal while the selector is used for determining a transmission or receiving sequence of a signal on the pins of the data pin port according to the control signal.

Another objective of the invention is to provide a liquid crystal display which comprises the aforementioned timing controller, a panel, and a driving chip. The driving chip is used for driving the panel for display according to the signals. The liquid crystal display comprises a pin socket which is suitable for the timing controller and has one of two pin socket sequences for receiving signals. By changing the control signal, the signal sequence of the pin socket transmitted to or received from the timing controller can be controlled.

This invention is suitable for the liquid crystal display with different circuit types and the controlling method is simple. Not only can complex manufacturing processes and fabrications be avoided, but the design and manufacturing costs for different timing controllers can be reduced.

The detailed technology and preferred embodiments implemented for the subject invention are described in the following paragraphs accompanying the appended drawings for people skilled in this field to well appreciate the features of the present invention.

### BRIEF DESCRIPTION OF THE DRAWINGS

FIG. 1 is a schematic diagram of a conventional face-up component;

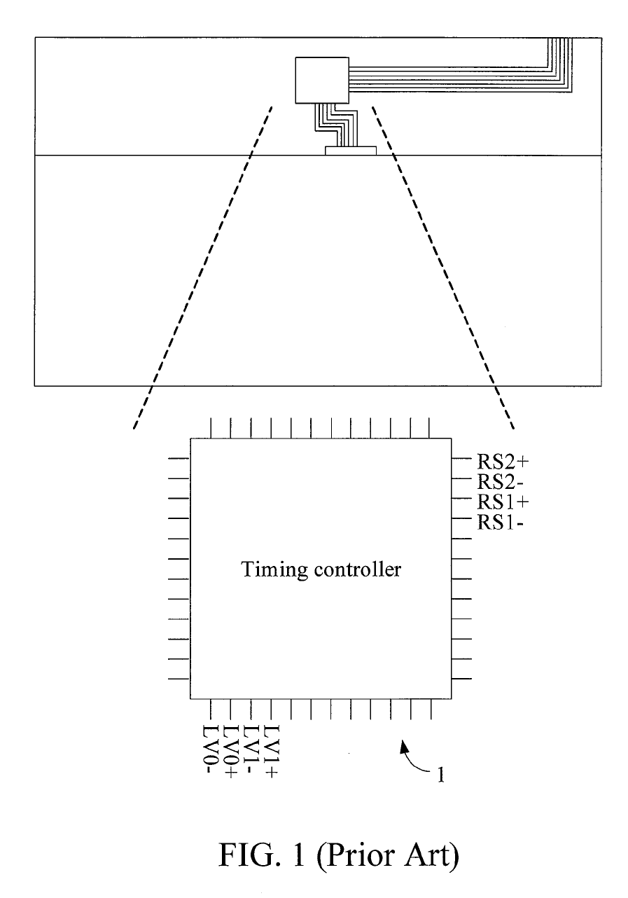

FIG. 2 is a schematic diagram of a conventional face-down component;

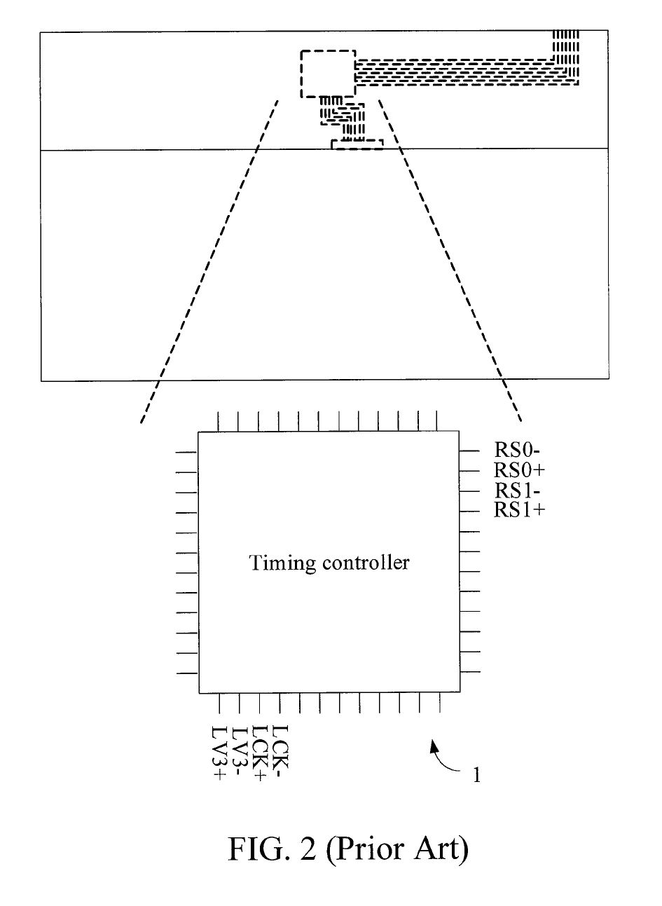

FIG. 3 is a schematic diagram of a timing controller with logic 1 of the preferred embodiment in accordance with one embodiment of the invention;

FIG. 4 is a schematic diagram of a timing controller with logic 0 of the preferred embodiment in accordance with one embodiment of the invention;

FIG. 5 is a schematic diagram of a thin film transistor liquid crystal display of the preferred embodiment in accordance with one embodiment of the invention; and

FIG. 6 is a schematic diagram of a multiplexer in accordance with one embodiment of the invention.

### DESCRIPTION OF THE PREFERRED EMBODIMENT

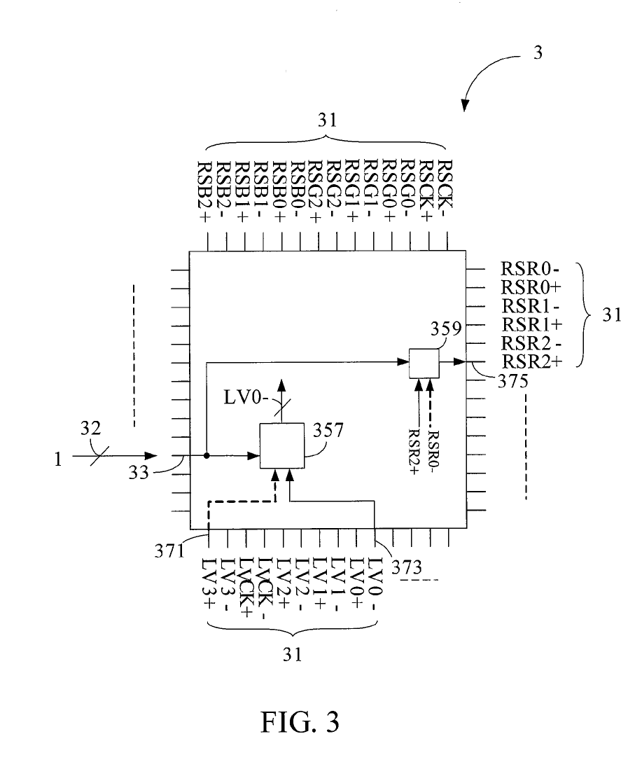

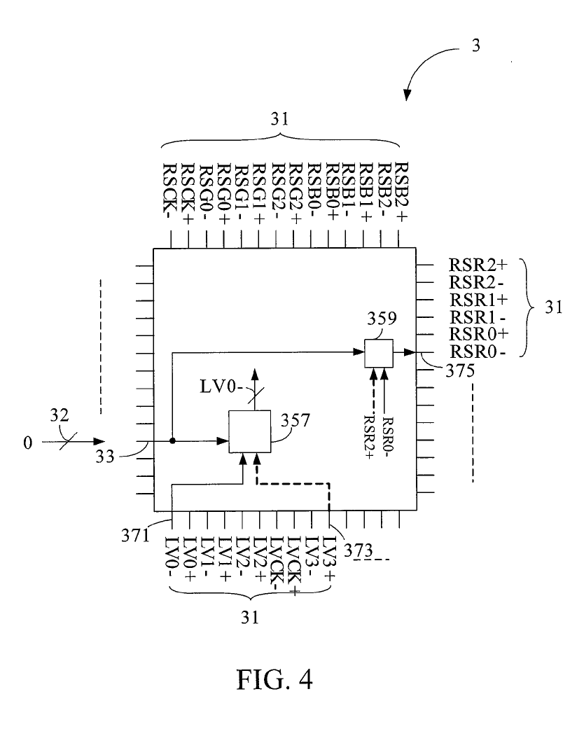

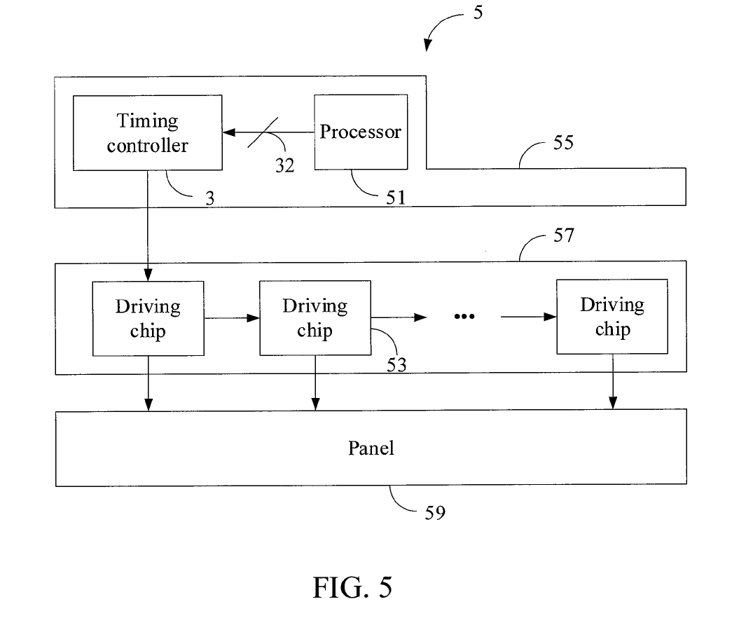

A preferred embodiment of this invention is directed to a timing controller 3 as shown in FIG. 3 and FIG. 4. The timing controller 3 implanted in a chip is used in a liquid crystal display, specifically in a thin film transistor (TFT) liquid crystal display 5, as shown in FIG. 5. The thin film transistor liquid crystal display 5 comprises a timing controller 3, a processor 51, a plurality of cascaded driving chips 53, a printed circuit board 55, a glass substrate 57, and a panel 59. The processor 51 generates a control signal 32 and a plurality of signals, and transmits these signals to the timing controller 3. The signals comprise reduced swing differential signals (RSDSs), output clock signals, low voltage differential signal (LVDSs), and input clock signals.

The timing controller 3 is disposed on the printed circuit board 55, which comprises a data pin port 31, a control pin 33, and a selector. The data pin port 31 comprises a plurality of pins which can be divided into RSDS pins, output clock signal pins, LVDS pins, input clock signal pins, etc. The aforementioned pins are in pairs of a positive level and a negative level. Therefore, the data pin port 31 has even pins.

The control pin 33 is used for receiving the control signal 32. The control signal 32 can be a voltage signal. When the input voltage signal is at a high level, the control signal 32 is in a logic 1 state. When the input voltage signal is at a low level, the control signal 32 is in a logic 0 state. The level of the control signal 32 is determined by a face-up circuit configuration and a face-down circuit configuration of the timing controller.

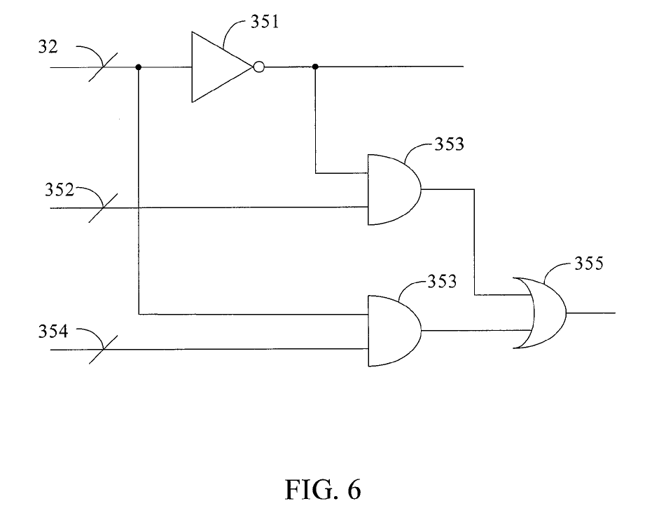

The selector determines a transmission or receiving sequence of the pins of the signals of the data pin port 31 according to the control signal 32. After the driving chips 53 on the glass substrate 57 receive the signals, the panel 59 is driven to display according to the signals. In this embodiment, the selector is a multiplexer as shown in FIG. 6. The multiplexer used in this embodiment comprises an inverter 351, two AND gates 353, and an OR gate 355. When the control signal 32 is 0, an output of the multiplexer is a first input signal 352. When the control signal 32 is 1, the output of the multiplexer is a second input signal 354.

When the control signal 32 is in the logic 1 state as shown in FIG. 3, the timing controller 3 is applied to the face-down configuration of the chip. The LVDS inputs in counterclockwise order are LV3+, LV3−, LVCK+, LVCK−, LV2+, LV2−, LV1+, LV1−, LV0+, and LV0− (LV means LVDS, the number represents a sequence of a signal pair), wherein LVCK+/−are a pair of low voltage differential clock input signals, and LV3+/−to LV0+/−are pairs of low voltage differential input signals. The RSDS outputs in counterclockwise order are RSR2+, RSR2−, RSR1+, RSR1−, RSR0+, RSR0−, RSG2+, RSG2−, RSG1+, RSG1−, RSG0+, RSG0−, RSCK+, RSCK−, RSB2+, RSB2−, RSB1+, RSB1−, RSB0+, and RSB0− (RS means RSDS). RSCK+/−are a pair of reduced swing differential clock signals for output. RSR2+/−, RSR1+/−, and RSR0+/−are pairs of red reduced swing differential output signals. RSG2+/−, RSG1+/−, and RSG0+/−are pairs of green reduced swing differential output signals. RSB2+/−, RSB1+/−, and RSB0+/−are pairs of blue reduced swing differential output signals.

When the control signal 32 is in the logic 0 state as shown in FIG. 4, the timing controller 3 is applied to the face-up configuration of the chip. The LVDS inputs in the counterclockwise order are LV0−, LV0+, LV1−, LV1+, LV2−, LV2+, LVCK−, LVCK+, LV3−, and LV3+, wherein LVCK−/+are a pair of low voltage differential input clock signals, and LV0−/+ to LV3−/+are pairs of low voltage differential input signals. The RSDS outputs in counterclockwise order are RSR0−, RSR0+, RSR1−, RSR1+, RSR2−, RSR2+, RSCK−, RSCK+, RSG0−, RSG0+, RSG1−, RSG1+, RSG2−, RSG2+, RSB0−, RSB0+, RSB1−, RSB1+, RSB2−, and RSB2+. RSCK−/+are a pair of reduced swing differential clock signals. RSR0−/+, RSR1−/+, and RSR2−/+are pairs of red reduced swing differential output signals. RSG0−/+, RSG1−/+, and RSG2−/+are pairs of green reduced swing differential output signals. RSB0−/+, RSB1−/+, and RSB2−/+are pairs of blue reduced swing differential output signals.

In fact, each pin of the data pin port 31 may output or take an input signal with two different definitions. Using the pin 317 as an example, the pin 371 is used for receiving the low voltage differential signal. When the control signal 32 is in the logic 1 state, the received voltage differential signal is defined as LV3+. When the control signal 32 is in the logic 0 state, the received voltage differential signal is defined as LV0−.

In a sequence selection of the low voltage differential signals and the input clock signals is shown in FIG. 3 and FIG. 4, which are an example that LV0− is the signal requiring input processing. The received signal of one of the pin 371 and the pin 373 is defined as LV0−, and input signals of both pins are hence inputted to a first multiplexer 357 for selection according to the control signal 32. When the logic level of the control signal 32 is 0, the input signal of the pin 371 is selected as LV0−. When the logic level of the control signal 32 is 1, the input signal of the pin 373 is selected as LV0−.

Next, the reduced swing differential signals and the output clock signals are described as follows. A selection of RSR0− signal or RSR2+ signal as the output of the pin 375 is used as an example. Determining whether the output signal of the pin 375 is RSR0− or RSR2+ depends on the face-up or face-down configuration. Therefore, the two output signals are inputted to a second multiplexer 359 for selection according to the control signal 32 before outputting the two output signals from the timing controller 3. When the logic level of the control signal 32 is 0, RSR0− is selected as the output signal. Otherwise, RSR2+ is selected as the output when the logic level of the control signal 32 is 1.

In addition to each kind of aforementioned pin, the timing controller of this invention further comprises some pins configured for basic functions, such as power pins for providing power to the timing controller, ground pins, and pins for transmitting control signals to the driving chips for controlling the liquid crystal display. Furthermore, the timing controller can also comprise pins for other functions for expanding practicability of the timing controller.

The timing controller of this invention can be expanded to a dual-port input/output. That is, output pins of the RSDS and input pins of the LVDS are doubled to increase processing of data amounts.

This invention changes an input signal of a specific pin to adapt the timing controller to the liquid crystal display with two face-up and face-down configurations. Because of the differences of face-up or face-down configurations, the prior art causes an improper sequence of input and output differential signals so that when designing a printed circuit board, the circuit has to be designed in different layers to avoid a circuit overlapping problem. However, this leads to poorer impedance matching of differential signals. Consequently, two timing controllers with different definitions of differential signal pins are provided for traditional use. This invention solves the problem of duplicated developments. Not only does this solution avoid the complications associated with separate transportation, storage, and assembling, but also reduces component design and manufacturing costs.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A timing controller, comprising:
a data pin port comprising a plurality of pins;
a control pin for receiving a control signal; and
a selector for determining a transmission or receiving sequence of a signal on the pins of the data pin port according to the control signal.

2. The timing controller as claimed in claim 1, wherein the signal comprises a low voltage differential signal.

3. The timing controller as claimed in claim 1, wherein the signal comprises a reduced swing differential signal.

4. The timing controller as claimed in claim 1, wherein the signal comprises a clock signal.

5. The timing controller as claimed in claim 1, wherein the selector comprises a multiplexer.

6. The timing controller as claimed in claim 1, wherein a level of the control signal is determined by a face-up circuit configuration and a face-down circuit configuration of the timing controller.

7. A liquid crystal display, comprising:
a timing controller, comprising:
a data pin port comprising a plurality of pins;
a control pin for receiving a control signal;
a selector for determining a transmission or receiving sequence of a signal on the pins of the data pin port according to the control signal;
a panel; and
a driving chip for driving the panel for display according to the signals.

8. The liquid crystal display as claimed in claim 7, wherein the signal comprises a low voltage differential signal.

9. The liquid crystal display as claimed in claim 7, wherein the signal comprises a reduced swing differential signal.

10. The liquid crystal display as claimed in claim 7, wherein the signal comprises a clock signal.

11. The liquid crystal display as claimed in claim 7, wherein the selector comprises a multiplexer.

12. The liquid crystal display as claimed in claim 7, wherein a level of the control signal is determined by a face-up circuit configuration and a face-down circuit configuration of the timing controller.
